(19) United States
(12) Patent Application Publication
(10) Pub. No.: US 2017/0011302 A1
(43) Pub. Date: Jan. 12, 2017

(54) ACTION CORRELATION FRAMEWORK

(71) Applicant: Microsoft Technology Licensing, LLC, Redmond, WA (US)

(72) Inventors: Dilnaz I. Heckman, Kirkland, WA (US); Yuanbo Guo, Redmond, WA (US); Mohit Arjunkumar Pande, Kirkland, WA (US); Yonis Yassin Mohammed, Bellevue, WA (US); Michael Scott Pierce, Seattle, WA (US)

(21) Appl. No.: 14/795,593

(22) Filed: Jul. 9, 2015

(51) Int. Cl. G06N 5/04

(52) U.S. Cl. CPC G06N 5/047

(57) ABSTRACT

Described are methods, systems, and computer program products for correlating operational information with subsequent action information. Operational information is received from a computing system performing one or more services. Pattern matching is performed for the operational information with data within a knowledge base. Based on the results of the pattern matching, a subsequent action associated with the operational information is determined.

### CROSS-REFERENCE TO RELATED APPLICATIONS

N/A.

### BACKGROUND

1. Background and Relevant Art

Computer systems and related technology affect many aspects of society. Indeed, the computer system's ability to process information has transformed the way we live and work. Computer systems now commonly perform a vast and diverse variety of tasks. Some tasks, prior to the advent of computer systems, were performed manually. Other tasks now routinely performed by and within computer systems were simply impossible prior to computers. In some cases, computer systems have been coupled to one another and to other electronic devices and systems to form both wired and wireless computer networks. Over such networks, computer systems and other electronic devices can share and transfer electronic data and divide and share computing tasks. Common tasks can be performed by shared computing systems and complex tasks can be divided into smaller tasks which can be performed by multiple computing systems. Accordingly, the performance of many computing tasks are distributed across a number of different computer systems and/or a number of different computing environments. These computing systems and computing environments, in some cases, may be systems and environments which are shared by multiple users and/or shared by multiple organizations. Such shared systems and environments may be available over communication networks or be so-called cloud-based systems.

It is not uncommon for and event or events which may occur during the course of performing a computing task to raise associated issues. Such events might be error events such as a task failing on a computing system operating to perform the task. Such events might also include the successful completion of a task, delay of a task, or some notice of circumstances affecting the performance or completion of a task. In some cases, an event or events occurring during the performance or attempted performance of a task will cause a user to seek an appropriate action to take after the occurrence of the event.

### BRIEF SUMMARY

The present invention extends to methods, systems, and computer program products for correlating operational information with subsequent action information. In one embodiment, operational information is received from a computing system performing one or more services. Pattern matching is performed with data contained within a knowledge base for the received operational information. A subsequent action associated with the operational information may then be selected based on the results of the pattern matching.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture which illustrates a correlation framework in a computing system.

FIG. 2 illustrates example operational information, pattern, and subsequent action correlation.

FIG. 3 illustrates a flow chart of an example method for correlating subsequent actions based upon matching a pattern of operational events.

### DETAILED DESCRIPTION

The present invention extends to methods, systems, and computer program products for correlating operational information with subsequent action information. In one embodiment, operational information is received from a computing system or systems performing one or more services. Pattern matching for the received operational information is performed with data contained within a knowledge base. A subsequent action associated with the operational information may then be selected based on the results of the pattern matching.

One embodiment may include a system which is enabled to correlate operational information with subsequent action information. Another embodiment may include a method performed in a computing environment to correlate operational information with subsequent action information. Another embodiment may include a data storage device storing computer executable instructions which, when executed upon and/or within appropriate computing hardware, can cause the hardware to correlate operational information with subsequent action information.

Embodiments of the present invention may comprise or utilize a special purpose or general-purpose computer including computer hardware, such as, for example, one or more computer processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable devices (i.e., physical storage devices) are items of manufacture (i.e., hardware) that store computer-executable instructions. Computer-readable media that carry computer-executable instructions are termed “transmission media.” Thus, by way of example, and not limitation, embodiments of the invention can comprise at least two distinctly different kinds of computer-readable media: computer storage devices and transmission media.

Computer storage devices may include RAM, ROM, EEPROM, CD-ROM or other optical disk storage, magnetic disk storage or other magnetic storage devices, or any other physical medium which can be used to persistently store data and/or program code means in the form of computer-executable instructions or data structures and which can be accessed by a general purpose or special purpose computer. Storage devices are hardware items (i.e., articles of manufacture) and do not include data transmission media such as wireless signals.

A network is defined as one or more data links that enable the transport of data between computer systems and/or modules and/or other electronic devices. When information is transferred or provided over a network or another communications connection (e.g., hardwired, wireless, electronic, optical, or any combination of communication connections) to a computer, the computer properly views the connection as a transmission medium. Transmissions media can include network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions, data, and/or data structures can be transferred from transmission media to computer storage media (or vice versa). For example, computer-executable instructions or data structures received over a network or data link can be buffered in RAM within a network interface module (e.g., a “NIC”), and then eventually transferred at a computer system to computer system RAM and/or to less volatile computer storage media such as magnetic or optical storage media. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, machine code, binaries, intermediate format instructions such as assembly language, source code which can be compiled into suitable machine code or binary format, and/or source code which can be executed within a runtime environment. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and other systems and platforms as are known in the art. The invention may also be practiced in distributed, networked, and cloud-based computing environments where local and remote computer systems, which are linked (either by hardwired data links, wireless data links, electronic data links, optical data links, or by any combination of data communication links) through a network, may each perform some or all computing tasks. In a distributed, networked, and/or cloud-based computing system environment, portions of executable code and/or program modules may be located in both local and remote memory storage devices and may be executed in both local and remote systems.

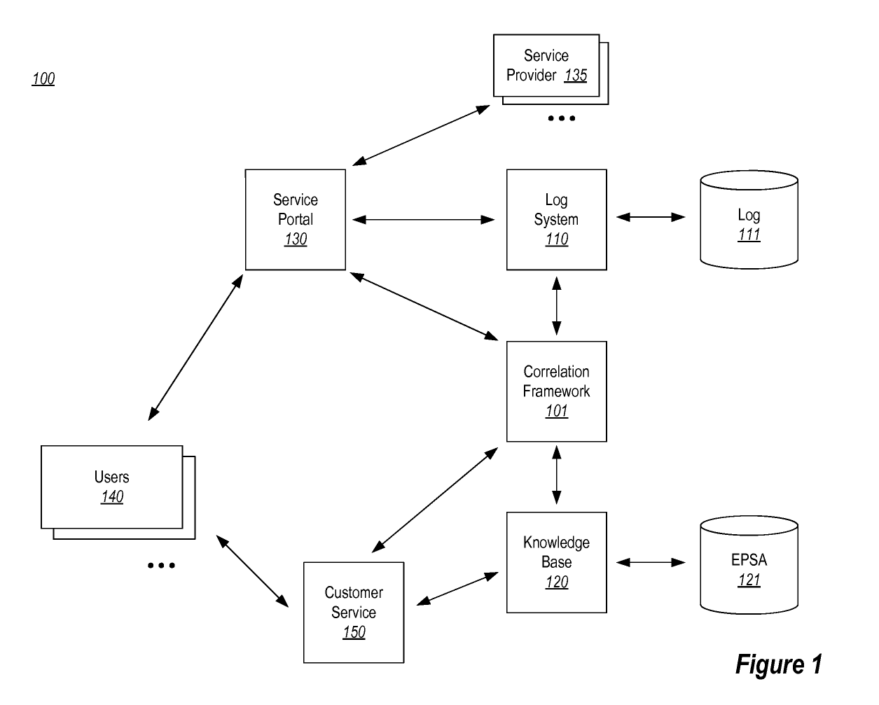

FIG. 1 illustrates an example computer architecture that facilitates correlating operational information with subsequent action information. Referring to FIG. 1, a computer architecture 100 for correlation framework 101 for correlating operational information with subsequent action information includes each of a number of components. Computer architecture 100 for correlation framework 101 may include each of a service portal 130, a Log System 110, log data storage 111, a knowledge base 120, event, pattern, and subsequent action (EPSA) data storage 121, a customer service computing system 150, and one or more user computing systems 140. (It is important to note that not all of the sub-systems depicted in the example architecture of FIG. 1 are necessary for implementation of various embodiments of the invention. Embodiments of the invention can, in fact, be implemented and/or performed with only a subset of the depicted sub-systems. Further, each of the sub-systems depicted in the example architecture may be implemented in computer systems as previously described, may be implemented in separate computing systems, may be implemented in multiple systems in a distributed fashion, and multiple depicted sub-systems may be implemented within a single computing system. Please also note that “customer” in Customer Service 150 is used for convenience but does not imply that the subsystem applies only to users having a customer relationship with some other entity. “Customer” in this sense should be interpreted broadly to include any user of any service which may be accessed and/or utilized through Service Portal 130 (and/or its equivalents).)

A correlation framework 101 may include a computing system comprising one or more computer processors, data storage, and computer-executable instructions for correlating operational information with subsequent action information. The depicted systems, correlation framework 101, service portal 130, a Log System 110, knowledge base 120, customer service computing system 150, and one or more users 140, etc., may be connected to one another, communicate with one another, and interact over (or may be part of) a network. Such a network may be, for example, a Local Area Network (LAN), a Wide Area Network (WAN), the Internet, etc. Such a network may utilize, for example, optical and/or electronic data communication links. Accordingly, each of the depicted computer systems as well as any other connected computer systems and their components, can create message related data and exchange message related data (e.g., Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network. Further, each of the depicted computer systems as well as any other connected computer systems comprises or has access to appropriate network communications hardware and interfaces (as are well-known in the art).

In a basic form, a correlation framework system 101 can receive operational information from a service portal 130 which performs one or more services. Services may be provided directly by a service portal, such as service portal 130, or may be provided by one or more service providers such as service providers 135. In some embodiments, a service portal 130 may coordinate services with users 140 and one or more service providers 135. Service portal 130 may provide services itself or may be a gateway which coordinates services to be provided by other service providers 135. Accordingly, operational information may be provided by a service portal, such as service portal 130, which may be providing services itself or coordinating services for possibly multiple users 140 and possibly multiple service providers 135. Service portal 130 may provide operational information after receiving such information from a service provider 135. Further, operational information may be provided directly by a service provider 135. This architecture allows that one or more portals may act as a gateway for multiple service providers 135, located locally or remotely, as may be encountered in a network or cloud-based application or service providing environment.

Operational information may be, for example, event log information or records which comprise information associated with events or operational states occurring in the service portal 130 or providing system 135 while performing certain tasks. (In the subsequent discussion, although described as operational information being sent or received from the service portal 130, it should be noted that embodiments of the invention include tasks being performed by, and operational information being sent and/or received from, a single service portal 130 as well as possibly multiple service portals and possibly multiple service providers 135.) Such event and/or operational information may include error event data, normal operational data, operational state data, system environmental data, task or system operational tracing data, etc.

The operational information may be information received from the service providing system 130 by a log system 110 and stored in a data log 111. The correlation framework 101 may receive the operational information from the log system 110. Alternatively, the correlation framework 101 may receive the operational information directly from the service providing system 130.

Once the correlation framework 101 has received operational information, it can then compare the received operational information with data stored by a knowledge base 120. The knowledge base 120 may have stored event information and associated action information. The knowledge base may have information which can be extracted, calculated, or determined from prior operational information and have action information which is associated with the extracted, calculated, or determined information.

For instance, a knowledge base may have information determined from an out-of-memory error event and may have an action, add or free memory, which is associated with alleviating the out-of-memory error. Information within the knowledge base may also be much more complicated than a simple, single, event. For instance, a knowledge base may have information concerning a series or sequence of events which ultimately resulted in a particular event, situation, or operational state (such as an error). Associated with the information concerning the series or sequence of events, the knowledge base may have an action or set of actions which can alleviate the error, prevent the error from recurring, improve or otherwise alter the operational state, or any combination. For instance, the knowledge base may have a series of events such as

i) create a message,

ii) add attachment to a message, and

iii) send message

which are correlated with an out of memory error. The associated action might be to reduce the size of the attachment attached to the message. The associated action might also be to warn a user to include with a message only attachments which are smaller than a maximum attachment size.

Although described as an event or sequence of events, the knowledge base may also have a collection of events which, although not a sequence in any particular order, are also associated with some other particular event, situation, error, or operational state, etc. For instance, a user may attempt to initiate tasks A, B, and C simultaneously and, although not initiated in any particular order, may cause a particular operational state (e.g., a processing resource constraint). The knowledge base may have an action, such as one or both of a suggestion to a user to increase subscribed resources, or a suggestion that only two of A, B, and C be performed simultaneously, which is associated with the combination of A, B, & C. Accordingly, the knowledge base may have an event, sequence of events, or some not necessarily sequential combination of events which are associated with some possible or suggestible next action.

The correlation framework 101 can perform pattern matching between the received operational information and the data stored within the knowledge base 120 and/or within the event, pattern, and subsequent action (EPSA) data storage 121. As the knowledge base comprises event information and/or information which can be extracted, calculated, or determined from prior operational information, the correlation framework 101 can perform pattern matching between the received operational information and the information stored within the knowledge base. By comparing the received operational information with the data stored in the knowledge base, related patterns within the received operational information and within the information stored within the knowledge base can be detected.

Pattern matching may be performed using any and/or all techniques as are known in the art. Such pattern matching may be as basic as a simple lookup table which associates an event ID with a possible subsequent action and/or may be sophisticated and complex techniques for detecting similar and related patterns in compared datasets as are known in such computing fields as pattern matching, artificial intelligence, etc.

Based on the results of the pattern matching, the correlation framework 101 may then determine a proposed subsequent action (or actions) which are associated with the received operational information. By finding a correspondence of a pattern in the received operational information with a pattern in the data stored in the knowledge base, an action associated with the pattern within the knowledge base may be determined.

The determined action may be a suggested (or required) subsequent action to be performed after the event (or combination of events) described or contained within the received operational information.

Operational information may be a single event or may be multiple events. The multiple events may be a series of events or may be a collection of events. The series or collection of events may be related (e.g., all associated with a particular task) or may be seemingly unrelated (e.g., events which occurred during performance of seemingly unrelated tasks). Operational information may be event log records (or other data structures) which comprise data associated with an event or events which may occur on a service providing system (such as systems 130 or 135). Operational information and/or event log records may be recorded or stored by a log system such as log system 110.

In some embodiments, such a service providing system may be a network based (e.g., “cloud” based) service provider and/or application server. An example of such a service provider might be a Microsoft® Office365 application server as implemented by Microsoft, Inc., of Redmond, Wash. Such a service provider or application server may provide services or applications, such as office productivity applications, for users to invoke and use over a network. Such services and networks may be cloud-based services accessible to users over the Internet or other communication link.

Data structures (or event log records) which include operational information may include a variety of data and data fields relevant to events which occur on a service providing system. Such data and/or data fields included in log records (or other data structure for operational data) may include (but is not be limited to) data items such as:
tagID—an event identifier
userID—identifier of a user of the system and/or service
tenantID—identifier of an organization using the system and/or service
sessionID—identifier for a particular use session on the service providing system
serviceID—identifier of the service and/or application operating when the event occurred
timeStamp—time at which the event occurred
logLevel—a severity level identifier
eventData—data relevant to the event
etc.—any other field or data relevant to the event.
   (Note that the individual data field names given, such as “tagID,” are illustrative only but do not depict what actual field names may be in particular embodiments or implementations of the invention.)

Such data and/or data fields may be included in an event log record such as:

(tagID, userID, tenantID, sessionID, serviceID, timeStamp, logLevel, eventData, . . . ). As may be appreciated, an event log record or data structure generated by a service provider system and stored in a log by a log system may include some or all of the data fields depicted as well as other data fields which are not depicted. Further, such data fields may be in any order and particular implementations of the invention may structure such data fields in various different formats and/or encodings.

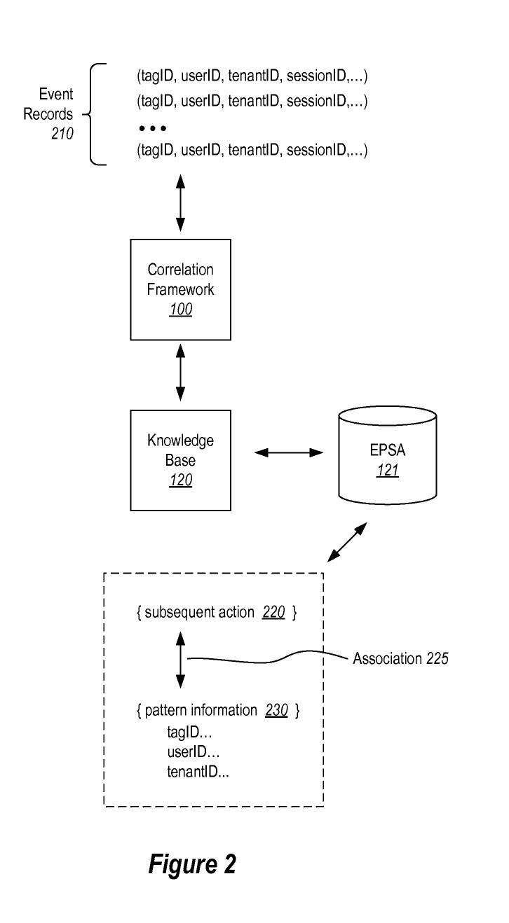

As depicted in FIG. 2, multiple such event log records 210 may be sent or received from service portal 130 (or service provider 135) to the log system 110 or the correlation framework 101. Each of the multiple event log records 210 (or other similar data structures) may comprise different values for some or all of the data fields to comprise operational information associated with some particular event, time, or state of some task being performed on or through service portal 130 (or service provider 135).

A tagID may be an identifier for a particular event. Such a tagID might identify the event as an error event. For example, an error event might be an out of memory event, an input data error, an insufficient user rights event, or any other event identified by a service providing system as an error. A tagID might identify the event as a normal processing event. Such a normal processing event might be something like a message sent successfully event, a document saved successfully event, a user login event, an application or task start or end event, etc. TagIDs may identify any event, error, operational state, normal operation, or otherwise. Different events and different types of events may all have distinct and/or unique tagIDs.

A userID may identify a user of a system, service, task, and/or application when an event occurs or associated with the event, system, service, task, and/or application.

A tenantID may identify an organizational user of a system, service, and/or application when an event occurs. For example, a tenantID may identify a company and a userID may identify a particular employee of the company who was using a system, service, and/or application when an event occurred.

A sessionID may identify a particular session for a system, service, and/or application when an event occurs. For instance, when a user logs into a service system to use a service or application, an identifying sessionID may be created to identify the particular session.

A serviceID may identify a particular system, service, and/or application which was being used when an event occurs. A timeStamp may identify the particular time at which a particular event occurred. Accordingly, a tagID can identify a type of event and userID, tenantID, sessionID, serviceID, timeStamp, etc., may be used to identify with particularity what service, what task, what application, what time, which particular user, which particular organization, etc., is associated with a particular event.

A logLevel may identify a severity level of an event. A logLevel may be a range of integers (or other identifiers) which identify the severity of an event and/or the level of event logging which is being generated. For example, logLevel may be an integer from 0-9 with logLevel=0 denoting that all events are logged or that a particular logged event is the least severe event possible (such as a normal operational event). In another example, a logLevel=9 may indicate that only the most severe errors are being logged or that a particular logged event is the most severe event possible (such as a catastrophic service stoppage or crash).

A log system, such as log system 110, may record and store some or all operational information received from a service providing system such as service providing system 130. A log system may store operational and event information in a data store such as log 111. Log 110 may be a database, a flat file storage system, or any other suitable data storage system. A log system may record and store only event log records which have a logLevel greater than a certain threshold or may store event log records which have a logLevel equal to certain values. An example would be to store all event log records which have a logLevel greater than 5 but to discard event log records having a logLevel equal to 5 or less. A log system may store operational and/or event information for a duration of time. For instance, a log system may store operational and/or event information for a period of time after the event occurred (such as for 1 day). A log system may also store operational and/or event information for a duration of time based on a logLevel for the event. For instance, a log system may store operational and/or event information for a period of time for a logLevel=9 (such as for 1 day) but store operational and/or event information for a different period of time for a logLevel=1 (such as for 10 minutes).

A correlation framework may be able to filter received operational information. For instance, the correlation framework may filter received operational information on any or any combination of the data fields included in the operational data such as tagID, userID, tenantID, sessionID, serviceID, timeStamp, logLevel, eventData, etc. For instance, if a particular user has userID-X the correlation framework may filter received operational information to determine a subset of the operational data comprising only events associated with userID-X. In another example, the correlation framework may filter received operational information to determine a subset of the operational data comprising only a particular eventID-Y associated with userID-X. In another example, the correlation framework may filter received operational information to determine a subset of the operational data comprising only a associated with userID-X and timeStamp after a certain time but before another time. As noted, the correlation framework may filter received operational information on any data field or any combination of the data fields included in the operational data.

In this fashion, the correlation framework can filter received operational data to a subset associated with a particular, tagID, userID, tenantID, sessionID, serviceID, timeStamp, logLevel, eventData, etc., and use that subset of operational information to perform pattern matching with data within the knowledge base. In this fashion, the correlation framework can determine a particular action 220 or actions which are associated 225 with a pattern 230 identified within the particular tagID, userID, etc. of the filtered subset of operational data.

By performing these described functions, the correlation framework 101 can provide the technical benefit of automatically, through computational pattern matching, determining a subsequent action which is associated with or appropriate to an event or set of events which are logged by the log system and described in the operational information. The correlation framework can thereby provide determined and/or suggested subsequent actions for events which are occurring in a service providing system.

In some embodiments, a correlation framework 101 may be communicatively connected to a customer service computing system 150. In this fashion, for example, a customer service representative may receive relevant information from a user desiring information and/or assistance with an issue or problem the user may be experiencing with a service, task, or application being utilized by the user. The user may be using a service or application that is hosted on or provided through the service providing system 130. The customer service system 150 may receive input identifying the user, the service, task, and/or application the user was using, etc. The customer service computing system may then relay the information identifying the user, the service, task, and/or application the user was using, as well as other associated information such as time, organization, authorization ID, etc., to the correlation framework 101. The correlation framework may then filter operational information stored within the log system 110 for data and/or records associated with the userID identifying the particular user and the serviceID identifying the service, task, and/or application the user was using to determine a subset of the operational information relevant to the user's inquiry. The correlation framework may then compare the subset of the operational information relevant to the user's inquiry with data in the knowledge base, perform pattern matching for the subset of the operational information relevant to the user's inquiry with data in the knowledge base and, based on the results of the pattern matching, determine a possible subsequent action 220 or actions which is associated 225 in the knowledge base 120 and/or event, pattern, and subsequent action (EPSA) data storage 121 with a corresponding or similar pattern of events.

The correlation framework 101 may then send data to the customer service computing system which identifies the determined subsequent action or actions which is associated in the knowledge base with the corresponding or similar pattern. The customer service computing system may then communicate the determined subsequent action to the inquiring user.

The correlation framework may also be communicatively coupled to a user computing system (such as user system 140). Such communicative coupling to a user system may be direct or may be indirect through an intermediary system (such as one or both of service providing system 130 or customer service system 150). In such a fashion, when a user encounters an event such as an error while using a service or application running on a service providing system, information identifying one or more of the user, the service, the event, etc. may be sent via the communication channel to the correlation framework. The correlation framework may then isolate a subset of operational information relevant to or associated with the user, the service, the event, etc., and perform pattern matching between the isolated subset of operational information and data in the knowledge base. Based on the results of the pattern matching, the correlation framework can determine a possible subsequent action or actions associated in the knowledge base with the matched pattern of events. The correlation framework can then transmit the determined action to the user system (either directly or through an intermediate system).

The determination of an associated subsequent event and transmission of an action to the user system can occur as a result of user input at the user system indicating a desire for information regarding a particular event. For instance, a user may be provided with a “more info” or “suggested action” input button on an alert presented to the user at the occurrence of an event. The user system may transmit an indication of the user having invoked the input button to the service portal, correlation framework, and/or customer service system and, as a result, the correlation framework can determine an associated subsequent action and cause it to be transmitted back to the user.

The customer service system may also be employed in a proactive fashion. For instance, if a cloud-based (or other) services provider identified a pattern of events which resulted in some operational state, the correlation framework can be used to match a known pattern within the knowledge base associated with the operational state with operational information being received from a service portal 130 or log system 110. When such corresponding patterns may be identified, then a customer service system (or the correlation framework, itself) may be proactive in communicating to associated users that they might be affected by the identified operational state and may be provided with an associated subsequent action or actions. This, in certain implementations, may be fully automated such that no human intervention may be required.

The functionality of the correlation framework may also be fully automatic. For example, when an event, such as an error, occurs while a service or application is performing some user-requested function, the correlation framework may recognize the event, determine a userID, tenantID, sessionID, etc., for the event. The correlation framework can then determine a subset of stored operational information associated with the event and perform pattern matching using that subset of stored operational information. Based on the results of the pattern matching, the correlation framework can then determine a suggested subsequent action associated with the event. The suggested subsequent action relevant to the event can then be transmitted back to the user computing system (either directly or indirectly). A user system (such as system 140) may then provide the determined subsequent action to a user through a user interface. Similarly, the correlation framework can automatically provide a determined or selected subsequent action to a user or customer support system (such as system 150).

The correlation framework may also include a feedback mechanism for increasing the accuracy of associated next actions and for including additional patterns in the knowledge base which may be associated with particular events and/or particular next actions. Such a feedback mechanism may be employed for augmenting the knowledge base with additional information associated with the received operational information and associating the additional information with the determined subsequent action.

By analysis of operational information associated with a particular event, the correlation framework can determine additional events or additional operational information which is associated with a particular event but which may not be included in the knowledge base. The correlation framework can then provide the determined additional events or additional operational information associated with the particular event to the knowledge base and associate it within the knowledge base with the particular event and/or a particular subsequent action. In this way, the knowledge base can be expanded and refined to include additional patterns which are associated with a particular event, operational state, and/or a particular subsequent action. By augmenting the data and patterns stored in the knowledge base in this fashion, the correlation framework will, over time, become more and more accurate in determining proper actions to be associated with particular events or patterns of events.

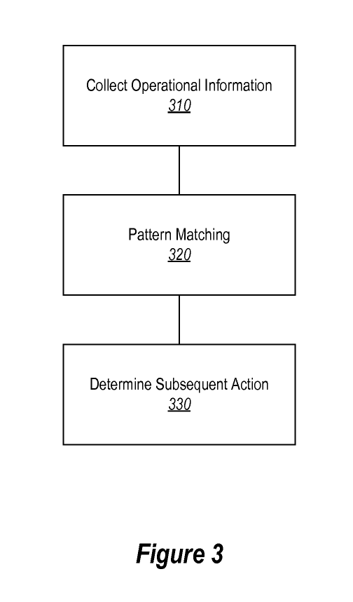

FIG. 3 illustrates a flow chart of an example method for correlating operational information with subsequent action information. The method for correlating operational information with subsequent action information will be described with respect to the components and data of computer architecture depicted in FIGS. 1 & 2. The method for correlating operational information with subsequent action information may be performed in a computing system which includes one or more processors, system memory, and appropriate communication hardware.

Step 310 in the method for correlating operational information with subsequent action information includes receiving operational information. Operational information, such as event records 210, is information generated by a service portal 130 (or service provider 135) which provides services and/or applications. The service providing system may be a network or cloud-based application portal and/or collection of service providers.

Operational information may include any information associated with a service or application running on the service providing system. Operational information may include event log records, such as event records 210, generated by a service providing system. Operational information and event log records may be stored in a log system such as log system 110. Operational information may include information associated with an error that occurred on the service providing system. Operational information may include usage information or usage events associated with tasks, services, and/or applications being performed on or through service portal 130. As described above, event log records may include such data as a tagID, userID, tenantID, sessionID, serviceID, timeStamp, logLevel, eventData, etc., which is associated with an event occurring on a service providing system. The service providing system may be a network-based or cloud-based service providing system and/or application server.

The method for correlating operational information with subsequent action information includes pattern matching 320 of the received operational information with data stored in a knowledge base. A knowledge base may include log event information and associated action information. A knowledge base may also include pattern information and associated action information. For instance, correlation framework 101 may perform pattern matching for event records 210 with corresponding patterns 230 which are stored in knowledge base 120 or event, pattern, and subsequent action (EPSA) data storage 121. Pattern matching may be performed for an entire set of operational information or some subset of operational information filtered by userID, serviceID, tenantID, etc., or other filtering criteria.

Pattern matching is performed for the operational information with patterns, such as pattern 230, stored in the knowledge base. Based on a result of the pattern matching, a subsequent action 220 associated 225 with the matched pattern may be determined and may be selected 330. Such a determined subsequent action may be an action designed to cure an error event, may be an action designed to alter some operational state, may be an action designed to gather additional information associated with an event, or may be an action which provides information (e.g., explains) a cause of an event. As may be appreciated, a varied and diverse set of actions may be associated with particular patterns stored within the knowledge base in order to accomplish various goals such as error correction, information gathering, information dissemination, etc.

In this fashion, patterns of events and patterns within logged operational information may be used by a correlation framework to determine matching patterns existing within a knowledge base comprising actions associated with known events and patterns of events and to determine an appropriate subsequent action based on the received operational information.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A system for correlating operational information with subsequent action information, the system comprising:
one or more computer processors;
persistent data memory; and
persistently stored computer executable instructions which, when executed upon the one or more processors, cause the system to:
receive operational information from a computing system performing one or more services;
perform pattern matching with a knowledge base for the operational information;
determining, based on the results of the pattern matching, a subsequent action associated with the operational information.

2. The system of claim 1, wherein the operational information comprises one or more usage events.

3. The system of claim 1, wherein the operational information comprises recorded event log information.

4. The system of claim 1, wherein the computing system performing one or more services is a network-based service providing system.

5. The system of claim 1, wherein the computing system performing one or more services is a network-based application server.

6. The system of claim 1, wherein the knowledge base comprises log event information and associated action information.

7. The system of claim 1, wherein the subsequent action comprises one or more actions for correcting an error.

8. The system of claim 1, further comprising automatically providing the subsequent action to a user.

9. The system of claim 1, further comprising automatically providing the subsequent action to a user support facility.

10. The system of claim 1, further comprising augmenting the knowledge base with additional information associated with the received operational information and associating the additional information with the determined subsequent action.

11. A computer implemented method for correlating operational information with subsequent action information, the method comprising executing computer executable instructions in a computing system to cause the computing system to:
receive operational information from a computing system performing one or more services;
perform pattern matching with a knowledge base for the operational information;
determining, based on the results of the pattern matching, a subsequent action associated with the operational information.

12. The method of claim 11, wherein the computing system performing one or more services is a network-based service providing system.

13. The method of claim 11, wherein the computing system performing one or more services is a network-based application server.

14. The method of claim 11, wherein the operational information comprises recorded event log information.

15. The method of claim 11, wherein the subsequent action comprises one or more actions for correcting an error.

16. The method of claim 11, further comprising automatically providing the subsequent action to a user.

17. The method of claim 11, further comprising automatically providing the subsequent action to a user support facility.

18. A computer program product for correlating operational information with subsequent action information, the computer program product comprising one or more data storage devices having encoded thereon computer executable instructions which, when executed upon one or more processors within a computing system cause the computing system to:
receive operational information from a computing system performing one or more services;
perform pattern matching with a knowledge base for the operational information;
determining, based on the results of the pattern matching, a subsequent action associated with the operational information.

19. The computer program product of claim 18, wherein the operational information comprises recorded event log information.

20. The computer program product of claim 18, wherein the computing system performing one or more services is a network-based application server.
